(19) United States
(12) Patent Application Publication
(10) Pub. No.: US 2012/0266189 A1
(43) Pub. Date: Oct. 18, 2012

(54) SYSTEM AND METHOD FOR DELIVERING TARGETED ADVERTISEMENT MESSAGES

(75) Inventors: Eduard Zaslavsky, Issaquah, WA (US); Arthur Vaysman, San Jose, CA (US)

(73) Assignee: WebTuner Corporation, Redmond, WA (US)

(21) Appl. No.: 13/440,364

(22) Filed: Apr. 5, 2012

Related U.S. Application Data
(60) Provisional application No. 61/471,954, filed on Apr. 5, 2011.

(51) Int. Cl. H04N 21/80

(52) U.S. Cl. 725/32

(57) ABSTRACT

Methods of creating and displaying video advertisements and systems implementing the methods are disclosed. The method includes creating a user interface wherein an advertiser chooses multi-media assets and their programmatically described rendering behavior, creating a user interface wherein the advertiser chooses a time, program, and audience to display the video advertisement to, transmitting multi-media assets and their programmatically described rendering behavior as a program to be stored on each member of the target audience's viewer devices, and transmitting a signal to each member of the target audience's viewer device to render multi-media assets and corresponding program for advertisement message.

### REFERENCE TO RELATED APPLICATIONS

This application claims priority to U.S. provisional application Ser. No. 61/471,954, filed Apr. 5, 2011, entitled “System and Method for Delivering Targeted Advertisement Messages,” which is hereby specifically and entirely incorporated by reference.

### BACKGROUND

1. Field of the Invention

The invention is directed to television advertisements, specifically, the invention is directed to targeted video advertisements.

2. Background of the Invention

Most Television (TV) channels make the bulk of their income through selling advertisement (ad or commercial) time slots. On a nationally broadcast TV show, usually a portion of the available advertisement time slots are reserved for national ads, while the remaining slots are available to local advertisers. Due to the high cost of ad time slots which must be bought in bulk and the high production costs of creating a video commercial, many local advertisers eschew TV advertising and instead choose to advertise over other media (e.g. newspaper or magazine ads, mailers, inserts, or radio commercials).

To become appealing to local advertisers, ideal system has to have:
Tools to reduce high cost of professional TV ad creation as compared to other media (e.g. newspaper or magazine ads, mailers, inserts, or radio commercials) making it price competitive.
TV ad delivery system capable of delivering small number of ads to targeted audience.
TV ad viewership data

### SUMMARY OF THE INVENTION

The present invention provides new tools and methods to overcome problems and disadvantages associated with current strategies and designs of creating and delivering TV advertisements.

Instead of creating an actual video ad for distribution over PayTV systems, the present invention offers to programmatically describe (in form of a script, bytecode for virtual machines, or compiled assembly for specific targeted CPUs) behavior of various combinations of multi-media assets such as photos, drawings, text, sound, etc. to generate on a viewer's device the equivalent of an advertiser's video ad message. Programmatic description in form of a program and multi-media assets can all be delivered to a viewer's device either ahead of time or in real-time and played back by the viewer's device, such as a set top box with pre-installed software capable of playing a programmatic description and multi-media assets, as a substitute to delivering, decoding, and playing an actual video ad. By using this method, it is possible to create ads that look like video ads when played by a viewer's device but are actually several hundred times smaller in size than a video of similar appearance and duration. The dramatic reduction in file size of TV ads makes it possible to use existing video broadcast systems to deliver targeted video ads equivalents without requiring such systems to transition to unicast video distribution. The same methodology can be used to reduce video ad production and video ad delivery costs (due to network's load reduction) in any video distribution systems.

An embodiment of the invention is directed to a method of creating, delivering, and rendering television (TV) video advertisements on at least one processing device. The method comprises creating a user interface wherein an advertiser chooses multi-media assets and corresponding programmatically described rendering behavior for rendering the advertisements on a viewer's device, transmitting the multi-media assets and corresponding programmatically described rendering behavior to the viewer's device, rendering the multi-media assets and the corresponding programmatically described rendering behavior.

In a preferred embodiment, the user interface wherein an advertiser chooses multi-media assets and corresponding programmatically described rendering behavior presents the user with a choice of TV advertisement templates. Preferably, the multi-media assets of the TV advertisement are chosen from images, text, audio, logos, buttons, interactive features, colors, fonts, URLs, and combinations thereof. Preferably, the method further comprises creating a user interface wherein the advertiser enters dialogue for the TV advertisement and chooses a voice actor to read the dialogue. In a preferred embodiment, the multi-media assets and corresponding programmatically described rendering behavior are stored on viewer's device.

Another embodiment of the invention is directed to a method of creating, delivering, and rendering video advertisements on at least one processing device. The method comprises creating a user interface wherein an advertiser chooses multi-media assets and corresponding programmatically described rendering behavior for rendering the advertisements on a viewer's device, creating a user interface wherein the advertiser chooses a target audience to display the video advertisement to, transmitting the multi-media assets and corresponding programmatically described rendering behavior to target audience's viewers' devices, rendering the multi-media assets and corresponding programmatically described rendering behavior on the target audience's viewers' devices.

Preferably, the user interface wherein the advertiser chooses a target audience to display the TV advertisement to comprises displaying a choice of at least one of a time frame for displaying the TV advertisement, at least one show during which to display the TV advertisement, the number of times to display the TV advertisement, the targeting attributes of the audience to display the advertisement to, and the amount of money to spend on an advertising campaign.

The method preferably further comprises creating a user interface wherein an advertiser can bid for a targeted audience. The method preferably further comprises sending the multi-media assets and corresponding programmatically described rendering behavior to each member of the target audience's device to be rendered by an advertisement message player and displayed as a TV advertisement.

Preferably, the method further comprises receiving a viewership report of at least one of advertisement rendering timestamp, advertisement viewing duration, and viewer's advertisement interaction from each member of the target audience's viewer device and transmitting at least a portion of the report to the advertiser.

Another embodiment of the invention is directed to a system for creating, delivering, and rendering Television (TV) video advertisements. The system comprises processing device, at least one viewer device in communication with the processing device, a data storage device coupled to each viewer device, software executing on the processing device, and software executing on each viewer device. The software executing on the processing device creates a user interface wherein an advertiser chooses multi-media assets and corresponding programmatically described rendering behavior for rendering the advertisements on a viewer's device, and transmits the multi-media assets and corresponding programmatically described rendering behavior to each viewer device. The software executing on each viewer device renders the multi-media assets and corresponding programmatically described rendering behavior on the viewer device.

Preferably, the user interface wherein an advertiser chooses elements and corresponding programmatically described rendering behavior displays a selection of TV advertisement templates. In a preferred embodiment, the multi-media assets of the TV advertisement are chosen from images, text, audio, logos, buttons, interactive features, colors, fonts, URLs, and combinations thereof. Preferably, the software executing on the processing device further creates a user interface wherein the advertiser enters dialogue for the TV advertisement and chooses a voice actor to read the dialogue. The multi-media assets and the corresponding programmatically described rendering behavior are preferably stored on viewer's device.

Another embodiment is directed to a system for creating, delivering, and rendering Television (TV) video advertisements. The system comprises a processing device, at least one viewer device in communication with the processing device, a data storage device coupled to each viewer device, software executing on the processing device, and software executing on each viewer device. The software executing on the processing device creates a user interface wherein an advertiser chooses multi-media assets and corresponding programmatically described rendering behavior for rendering the advertisements on a viewer's device, creates a user interface wherein the advertiser chooses a target audience to display the TV advertisement to, and transmits the multi-media assets and corresponding programmatically described rendering behavior to target audience's viewers' devices. The software executing on each viewer device renders the multi-media assets and corresponding programmatically described rendering behavior on targeted viewer's device.

Preferably, the user interface wherein an advertiser chooses a target audience to display the TV advertisement to comprises displaying a choice of at least one of a time frame for displaying the TV advertisement, at least one show during which to display the TV advertisement, the number of times to display the TV advertisement, the targeting attributes of the audience to display the advertisement to, and the amount of money to spend on an advertising campaign. In the preferred embodiment, the software executing on the processing device further creates a user interface wherein an advertiser can bid for a targeted audience.

Preferably, the software executing on the viewer device collects and transmits a viewership report. The viewership report preferably includes at least one of advertisement rendering timestamp, advertisement viewing duration, and viewer's advertisement interaction from each member of the target audience's viewer device and transmits at least a portion of the report to the advertiser. Preferably, the data storage device is one of RAM, FLASH, or a hard drive.

Other embodiments and advantages of the invention are set forth in part in the description, which follows, and in part, may be obvious from this description, or may be learned from the practice of the invention.

### DESCRIPTION OF THE DRAWING

The invention is described in greater detail by way of example only and with reference to the attached drawing, in which:

FIG. 1 is diagram of an embodiment of the system of the invention.

FIG. 2 is a flow chart of an embodiment of the method of the invention.

FIG. 3 is an embodiment of a template of the invention.

FIG. 4 is a diagram of a universal user experience generator.

FIG. 5 is a diagram of the dissemination of multiple commercials using the invention.

FIG. 6 is a diagram of a typical set-top box.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention

A problem in the art capable of being solved by the embodiments of the present invention is creating and delivering inexpensive TV advertisements. It has been surprisingly discovered that providing advertisers with a template based commercial creation system and storing components of the commercial at a viewer's end allows for a low cost targeted TV ad alternative.

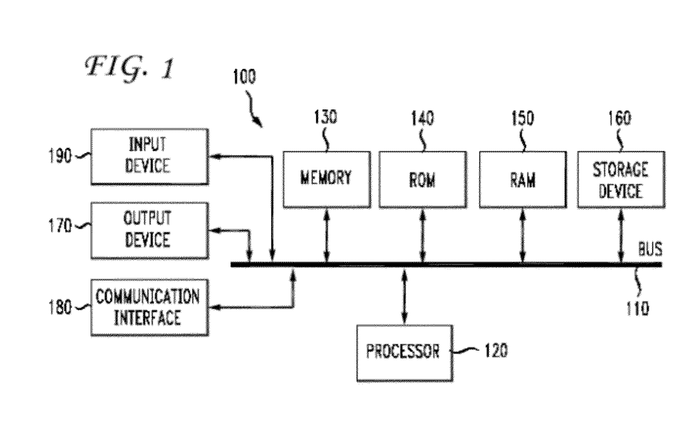

With reference to FIG. 1, an exemplary system includes at least one general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, a computer server, or a wireless devices, including wireless Smart Phones (e.g., Research in Motion's Blackberry™, Apple's iPhone™, or an Android™ device), wireless web-enabled phones, other wireless phones, tablets, etc.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, and so forth. The device output 170 can be one or more of a number of output mechanisms known to those of skill in the art, for example, printers, monitors, projectors, speakers, and plotters. In some embodiments, the output can be via a network interface, for example uploading to a website, emailing, attached to or placed within other electronic files, and sending an SMS or MMS message. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Networks may include the Internet, one or more Local Area Networks (“LANs”), one or more Metropolitan Area Networks (“MANs”), one or more Wide Area Networks (“WANs”), one or more Intranets, etc. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

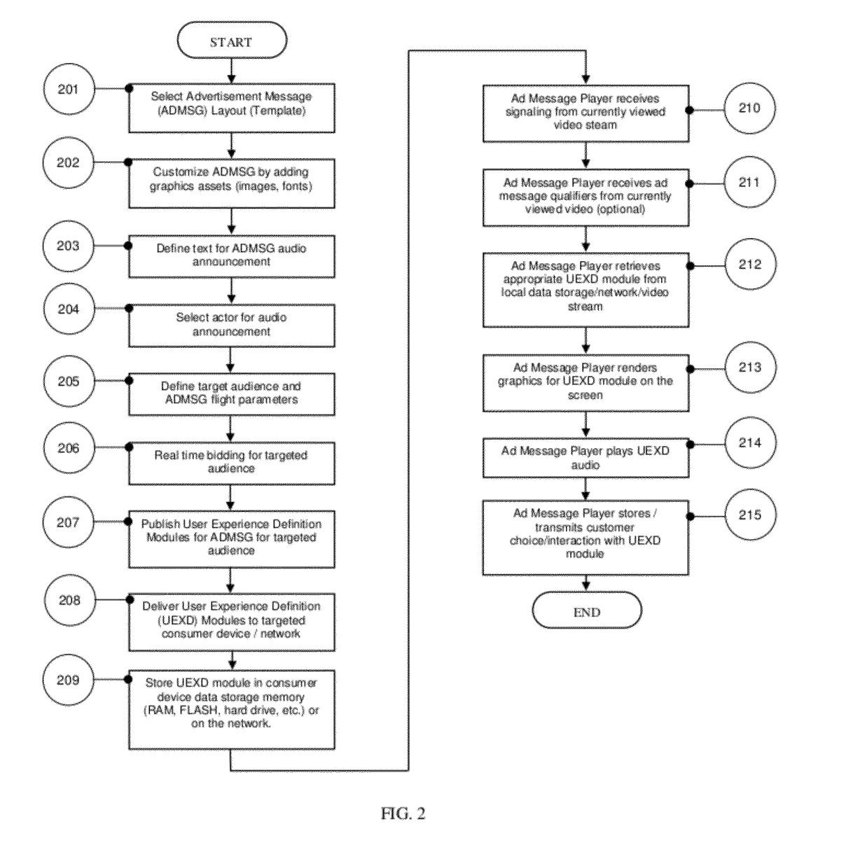

FIG. 2 is a flow chart of an embodiment of a method of the invention. In the preferred embodiment, an advertiser utilizes an Internet connection in order to access a website on a host computer. The website may, for example, be maintained and hosted by a TV station, a cable or satellite provider, or an Internet Service Provider. The website, when accessed, may request an advertiser to log into the site by entering a User Name and Password. However, in certain embodiments, additional information can be required, for example company identification. The User Name and Password can be an email address or combination of letters, numbers, and/or symbols. Preferably, each User Name is unique. Based on advertiser identification, access to the system can be determined. Furthermore, based on advertiser's identification, an advertiser's preferences, saved advertisements, accessible databases, and other resources the advertiser has access to, are uploaded.

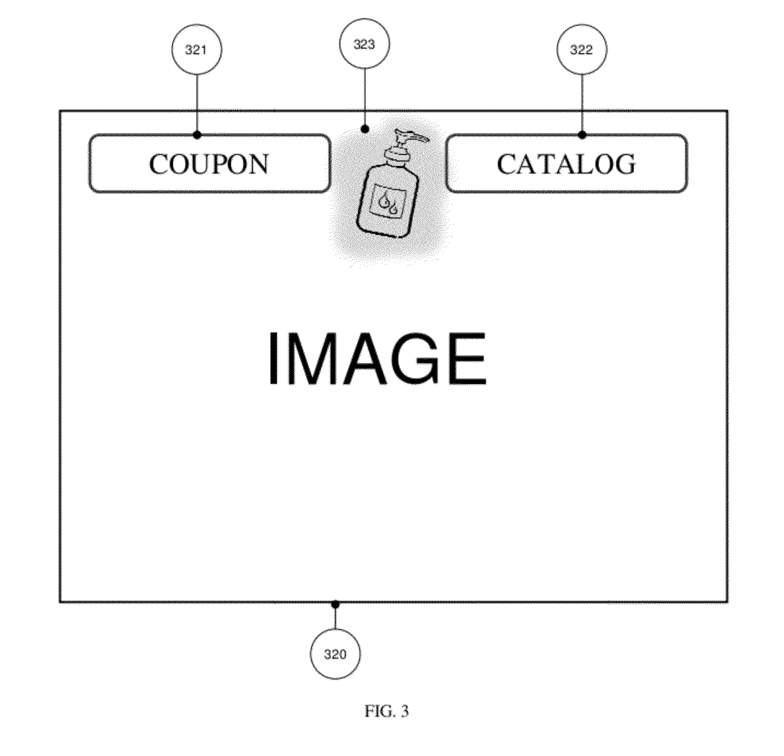

Upon logging in, an advertiser is presented with a selection of advertisement message layout templates 201. The advertiser chooses the desired template and is given the option of customizing the template 202. The advertiser can customize graphics, images, fonts, text or other visual elements. FIG. 3 depicts an example of an advertisement template 320. In template 320, for example, an advertiser can choose the text, font, and/or color to appear in text boxes 321 and 322. The advertiser can also choose the graphic to appear in image box 323 as well as any background or image to appear in the main body of template 320. Additionally, the advertiser can choose any changes to the template during the course of the advertisement. For example, if text or graphics change or move. In the preferred embodiment, the system maintains a database of images. However, the advertiser can upload custom images if desired. In certain embodiments, where viewers have interactive TVs that allow viewers to interact with the commercials, the system can allow advertisers to insert clickable buttons or other interactive elements into the commercial. For example, buttons may allow viewers to choose to purchase now, receive a coupon, or have a representative call the viewer.

Once the advertiser is satisfied with the visual aspects of the advertisement, the advertiser can customize the audio portion of the commercial 503. In a preferred embodiment, the system maintains a database of audio tracks including music, sound effects, and spoken words. Additionally, the advertiser can upload audio tracks if desired. The system can also provide the advertiser with the option of creating dialogue for the commercial and hiring a voice actor read the dialogue 504. The system will match the timing of the video portion of the commercial to the audio portion of the commercial, as the advertiser desires. Additionally, the advertiser can choose to create multiple commercials.

Once the commercial is created to the advertiser's specifications, the advertiser can choose a target audience and advertisement flight parameters 205, for example male or female target audience, campaign start time, campaign stop time. Furthermore, the advertiser can choose how often a commercial is delivered, or how much to spend on the advertising campaign. If the advertiser sets a maximum spending limit, the system may automatically determine the most cost effective use of the advertiser's funds and deliver the commercial accordingly.

When more than one advertiser chooses to use the same ad slot and target audience, the system may accept bids for the commercial space 206. In the preferred embodiment, the highest bidder will receive the time slot, however, other schemes can be implemented.

In order to reduce the bandwidth necessary to deliver the targeted commercial, the system pre-installs the necessary components on each viewer's set-top box (e.g. cable box, computer, streaming media device, smart TV, or gaming system) or other viewing device 207. For example, a viewer's set-top box can have software installed that is capable of receiving the images, text, audio, and other components of the commercial and compiling them into a viewable advertisement. In the preferred embodiment, the components of the commercial are delivered to the viewer's set-top box along with a script that the software can decipher and execute 208. The script allows the system to transmit low-bandwidth-consuming data without having to transmit video. The components of the commercial and the script can be delivered over cable lines, over the airways, or through another medium. In instances of interactive TV ads, the scripts can have instructions to request enhancements from the media service provider as necessary. As a result, the amount of bandwidth used to transmit the commercials based on the ad message (ADMSG) script will be significantly smaller than a standard definition or high definition video (e.g. achieving effective compression ratio of 100:1, 200:1, or 300:1).

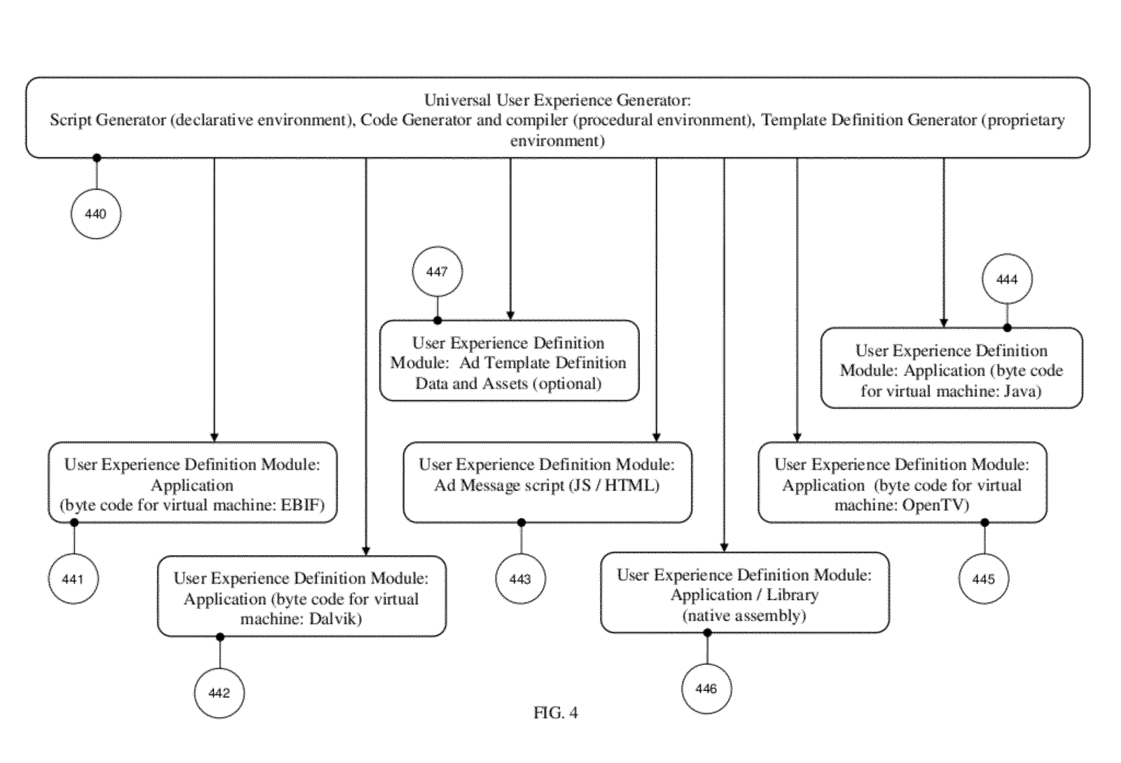

FIG. 4 depicts a schematic of the script generator 440. In a preferred embodiment, the commercial can be played on different platforms, including but not limited to EBIF 441, Dalvik 442, HTML 443, Java 444, open TV 445, other platforms 446.

In the preferred embodiment, the elements of the commercial and the commercial script are stored on a viewer's set-top box 209 or optionally can be delivered on-demand from User Experience Definition Module 447.

Preferably, the viewer's set-top box contains storage memory (e.g. RAM, FLASH, or a hard drive). The memory is preferably able to store multiple commercials' data at once. For example, the set-top boxes can store between 10 and 15 commercials. The system can update the saved commercial data by deleting old ads and saving new ads. For example the commercial data can be updated daily, weekly, dynamically, on demand, or as needed. Additionally, the set-top box may store a library of commonly used elements to further decrease bandwidth usage.

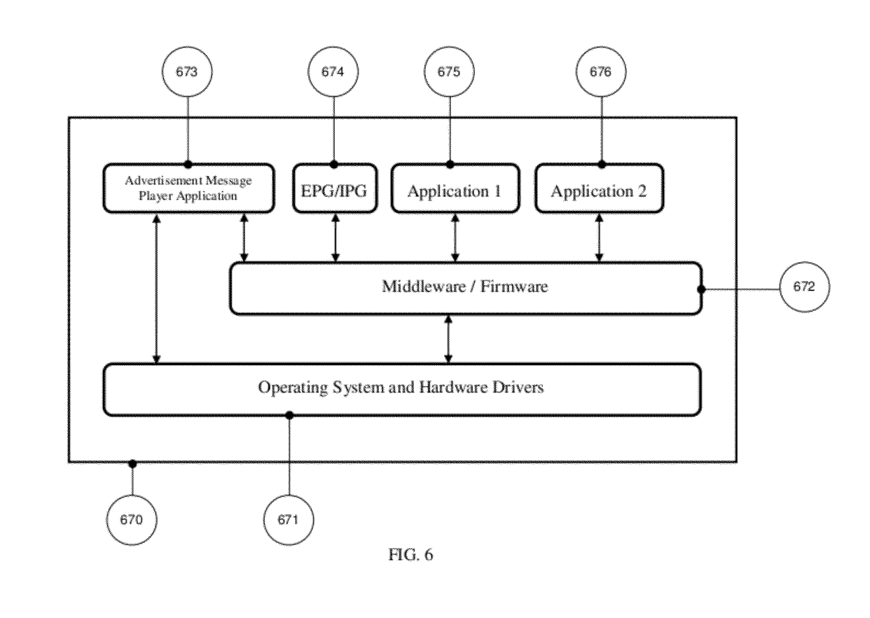

FIG. 6 depicts a block diagram of an example of a set-top box software stack 670. A typical set-top box software stack 670 includes an operating system and hardware drivers 671 and middleware or firmware 672. Advertisement Message Player Application 673 receives: User Experience Definition Module 447; targeted TV ad assets and script; and signaling from middleware 672 to render targeted TV ad.

In the preferred embodiment, the video stream includes metadata tags or other signals that indicate to the viewer's set-top box when to play a commercial and which commercial to play 210. The tag is preferably embedded in the video stream of the program that the viewer is currently watching. The tag is preferably placed into the video stream at a time position sufficient to give the set-top box enough time to assemble the advertisement and queue the advertisement for playing. Optionally, the video stream also contains qualifiers indicating the type of programming currently being watched by the viewer so that the set-top box will play an appropriate commercial. For example, if the show currently being watched is a children's show, the qualifier will indicate to the set-top box to only play child appropriate ads (e.g. the set-top box will not play alcohol related commercials).

When the appropriate spot in the video stream arrives, the set-top box will assemble the commercial 212 and play the video 213 and audio 214 portions of the commercial. Once the commercial is played, the set-top box can record the time of playing, show during which the commercial was played, viewership, demographics, and other data related to the commercial 515. The data can then be sent back to the system which can compile a report for the advertiser.

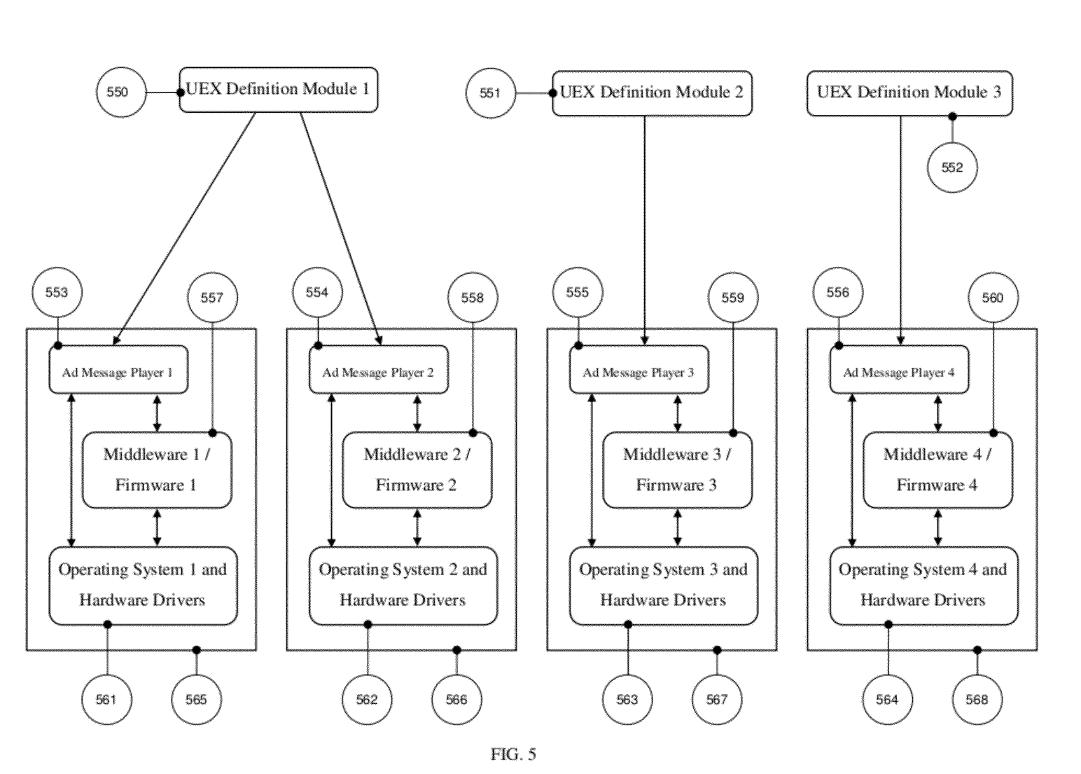

FIG. 5 is a schematic of multiple advertisements being displayed to multiple viewers. A commercial is generated at each of user experience definition modules 550, 551, and 552. The commercial generated at user experience definition module 550 is set to be displayed on viewer set-top boxes 565 and 566. Set-top boxes 565 and 566 can be different types of devices or the same type of device. Preferably, each set-top box 565 and 566 has an ad message player 553 and 554, software for compiling and displaying the commercials 557 and 558, and an operating system including hardware drivers 561 and 562. The commercial generated at user experience definition module 551 may be sent to only be displayed on viewer set-top box 567. Preferably, set-top box 567 has an ad message player 555, software for compiling and displaying the commercials 559, and an operating system including hardware drivers 563. The commercial generated at user experience definition module 552 may be sent to only be displayed on viewer set-top box 568. Preferably, set-top box 568 has an ad message player 556, software for compiling and displaying the commercials 560, and an operating system including hardware drivers 564.

In a preferred embodiment, each set-top box can also inject commercials into previously recorded programs (e.g. shows recorded on a DVR or Tivo device). In such embodiments, even though a program may have been recorded at an earlier date, the set-top box will inject an up to date commercial at the appropriate time.

### EXAMPLE

A retail business in a community serviced by a cable Multiple System Operator (MSO) can be provided with a computer-based application for generating a static graphical image in the form of an advertisement for the retail business. The application may be template-based and enable the addition of a variety of customizable features, including prompts for additional information, to respond to a query, or to purchase a good or service. The output of the application can be a series of text instructions to recreate the commercial at a viewer's set-top box. The set-top box has downloaded, in the set-top box's memory, a small application that acts as a decoder for the instructions, as well as a viewer/player to display the commercial on the viewer's video screen. The instructions can be transmitted to targeted customers using addressable logic, and stored in the memory of the cable box for future execution. In this way, a variety of customized commercials can be stored in existing set-top boxes and be display in response to control signals subsequently sent with the conventional video signal. The existing backchannel can be used to transmit viewer ad responses to the headend.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A method of creating, delivering, and rendering television (TV) video advertisements, comprising, on at least one processing device:
creating a user interface wherein an advertiser chooses multi-media assets and corresponding programmatically described rendering behavior for rendering the advertisements on a viewer's device;
transmitting the multi-media assets and corresponding programmatically described rendering behavior to the viewer's device;
rendering the multi-media assets and the corresponding programmatically described rendering behavior.

2. The method of claim 1, wherein the user interface wherein an advertiser chooses multi-media assets and corresponding programmatically described rendering behavior presents the user with a choice of TV advertisement templates.

3. The method of claim 1, wherein the multi-media assets of the TV advertisement are chosen from images, text, audio, logos, buttons, interactive features, colors, fonts, URLs, and combinations thereof.

4. The method of claim 1, further comprising creating a user interface wherein the advertiser enters dialogue for the TV advertisement and chooses a voice actor to read the dialogue.

5. The method of claim 1, wherein the multi-media assets and the corresponding programmatically described rendering behavior are stored on viewer's device.

6. A method of creating, delivering, and rendering video advertisements, comprising, on at least one processing device:
creating a user interface wherein an advertiser chooses multi-media assets and corresponding programmatically described rendering behavior for rendering the advertisements on a viewer's device;
creating a user interface wherein the advertiser chooses a target audience to display the video advertisement to;
transmitting the multi-media assets and corresponding programmatically described rendering behavior to target audience's viewers' devices;
rendering the multi-media assets and corresponding programmatically described rendering behavior on the target audience's viewers' devices.

7. The method of claim 6, wherein the user interface wherein the advertiser chooses a target audience to display the TV advertisement to comprises displaying a choice of at least one of a time frame for displaying the TV advertisement, at least one show during which to display the TV advertisement, the number of times to display the TV advertisement, the targeting attributes of the audience to display the advertisement to, and the amount of money to spend on an advertising campaign.

8. The method of claim 6, further comprising creating a user interface wherein an advertiser can bid for a targeted audience.

9. The method of claim 6, further comprising sending the multi-media assets and corresponding programmatically described rendering behavior to each member of the target audience's device to be rendered by an advertisement message player and displayed as a TV advertisement.

10. The method of claim 6, further comprising receiving a viewership report of at least one of advertisement rendering timestamp, advertisement viewing duration, and viewer's advertisement interaction from each member of the target audience's viewer device and transmitting at least a portion of the report to the advertiser.

11. A system for creating, delivering, and rendering Television (TV) video advertisements, comprising:
a processing device;
at least one viewer device in communication with the processing device;
a data storage device coupled to each viewer device;
software executing on the processing device, wherein the software:
creates a user interface wherein an advertiser chooses multi-media assets and corresponding programmatically described rendering behavior for rendering the advertisements on a viewer's device;
transmits the multi-media assets and corresponding programmatically described rendering behavior to each viewer device; and
software executing on each viewer device, wherein the software renders the multi-media assets and corresponding programmatically described rendering behavior on the viewer device.

12. The system of claim 11, wherein the user interface wherein an advertiser chooses elements and corresponding programmatically described rendering behavior displays a selection of TV advertisement templates.

13. The system of claim 11, wherein the multi-media assets of the TV advertisement are chosen from images, text, audio, logos, buttons, interactive features, colors, fonts, URLs, and combinations thereof.

14. The system of claim 11, wherein the software executing on the processing device further creates a user interface wherein the advertiser enters dialogue for the TV advertisement and chooses a voice actor to read the dialogue.

15. The system of claim 11, wherein multi-media assets and the corresponding programmatically described rendering behavior are stored on viewer's device.

16. A system for creating, delivering, and rendering Television (TV) video advertisements, comprising:
a processing device;
at least one viewer device in communication with the processing device;
a data storage device coupled to each viewer device;
software executing on the processing device, wherein the software:
creates a user interface wherein an advertiser chooses multi-media assets and corresponding programmatically described rendering behavior for rendering the advertisements on a viewer's device;
creates a user interface wherein the advertiser chooses a target audience to display the TV advertisement to;
transmits the multi-media assets and corresponding programmatically described rendering behavior to target audience's viewers' devices;
software executing on each viewer device, wherein the software renders the multi-media assets and corresponding programmatically described rendering behavior on targeted viewer's device.

17. The system of claim 16, wherein the user interface wherein an advertiser chooses a target audience to display the TV advertisement to comprises displaying a choice of at least one of a time frame for displaying the TV advertisement, at least one show during which to display the TV advertisement, the number of times to display the TV advertisement, the targeting attributes of the audience to display the advertisement to, and the amount of money to spend on an advertising campaign.

18. The system of claim 16, wherein the software executing on the processing device further creates a user interface wherein an advertiser can bid for a targeted audience.

19. The system of claim 16, wherein the software executing on the viewer device collects and transmits a viewership report.

20. The system of claim 19, wherein the viewership report includes at least one of advertisement rendering timestamp, advertisement viewing duration, and viewer's advertisement interaction from each member of the target audience's viewer device and transmits at least a portion of the report to the advertiser.

21. The system of claim 16, wherein the data storage device is one of RAM, FLASH, or a hard drive.
